(19) United States
(12) Patent Application Publication
(10) Pub. No.: US 2006/0092023 A1
(43) Pub. Date: May 4, 2006

(54) Device for detecting the occupancy of a seat

(75) Inventors: Klaus Hofbeck, Neumarkt (DE); Birgit Rosel, Regensburg (DE); Arnd Stielow, Regensburg (DE); Roland Wagner, Donaustauf (DE)

Correspondence Address: LERNER GREENBERG STEMER LLP, P O BOX 2480, HOLLYWOOD, FL, 33022-2480, US

(73) Assignee: Siemens AG

(21) Appl. No.: 11/254,043

(22) Filed: Oct. 19, 2005

(30) Foreign Application Priority Data
Oct. 19, 2004 (DE) 10 2004 050 884.4

(51) Int. Cl. G08B 13/26; B60R 21/16

(52) U.S. Cl. 340/561; 280/735; 180/273

(57) ABSTRACT

A seat occupancy detection device contains at least one transmitting apparatus and at least one receiving apparatus located at a position in a seat which position is distanced from the at least one transmitting apparatus such that a person occupying the seat will be situated at least partially in the signal path between the at least one transmitting apparatus and the at least one receiving apparatus for influencing the signals as a function of seat occupancy. In this manner, occupancy of the seat is effectively detected.

### BACKGROUND OF THE INVENTION

Field of the Invention

The present invention relates to a device for detecting the occupancy of a seat, in particular for detecting the occupancy of a front passenger seat located in a motor vehicle.

A device of this type can be used advantageously, though not exclusively, to control the actuation or, as the case may be, opening of a vehicle airbag so that the airbag actuator will be activated only if the appropriately assigned seat in the vehicle, for example the front passenger seat, is occupied.

It is becoming increasingly customary to fit vehicles with what are termed airbag restraints for both the driver and the front seat passenger. As it can be assumed that a driving seat will be occupied whenever the vehicle is in motion, it is generally desirable for the airbag on the driver side to be actuated in the event of the vehicle being subjected to negative acceleration above a certain threshold. The driver is frequently alone in the vehicle during such an occurrence, so it is not necessary to actuate the airbag on the front passenger side. Because unnecessary actuation of the airbag on the front passenger side will result in increased repair costs for reinstalling the airbag, there is a requirement on the part of, generally speaking, insurance companies to fit vehicles having a double airbag with an apparatus for deactivating the airbag on the front passenger side when it is unoccupied.

It is furthermore desirable based on wishes of the customer or legal requirements to fit the motor vehicle with a system that classifies a person or object occupying the seat. That will, for example, enable the airbag restraint for the front passenger seat to be activated only when an adult person is detected on the seat. On the other hand it is desirable not to trigger the airbag restraint when the system detects a child or, as the case may be, infant in a child seat least it be injured through triggering of the airbag.

There are, of course, many different ways to determine whether a seat in a vehicle is occupied. The vehicle can, for example, be provided with a simple on/off switch that can be activated manually by the driver or front seat passenger. A system of this type is, however, not preferred as the driver or front seat passenger may forget to activate the airbag actuator when the seat becomes occupied. What is accordingly sought is a detection device that will function without human intervention.

A vehicle seat having a load-dependent switch located in a seat cushion is known from U.S. Pat. No. 3,863,209. The switch will be activated, in turn activating the airbag sensor, when the seat is occupied by a person of sufficient weight. A disadvantage of such a system is that the load-dependent switch cannot distinguish between a living being and a heavy object possibly located on the seat.

It is also known how to employ optical or ultrasound-based transmitters and sensors for detecting the presence of a seat occupant, albeit such systems are relatively difficult to install. They require components to be mounted at various locations within the vehicle cabin. A system of this type is disclosed in, for example, published, non-prosecuted German patent application DE 4 023 109 A.

The fact that the above approaches according to the prior art can only be realized at the expense of substantial effort or cost has, however, proved disadvantageous. Nor, furthermore, is the efficiency of such systems or their proneness to faults optimal where many approaches are concerned.

A novel seat occupancy detection system currently being developed by the applicant and not yet made public is what is termed the human observation by beam interference technology (HOBBIT) system. The HOBBIT system includes a central base station and individual reflectors in the seat for detecting occupancy thereof. In the HOBBIT system the diffraction, attenuation and/or reflection of high-frequency signals (2.4-GHz waves, for example) is usefully employed to detect the occupancy of the seat by a person. With the HOBBIT system a space encompassing all the seating requiring to be monitored within a vehicle passenger compartment is illuminated with the high-frequency, electromagnetic wave field. For this purpose the base station emits signals that impinge on the reflectors from where, having been modulated there and reflected therefrom, they are received back by the base station.

The reflector responses thus obtained are evaluated in terms of their level. What is termed an attenuation thickness, being a measure of the attenuation by a material of specified thickness, is for this purpose generally determined for each of the reflectors associated with a seat. The attenuation thickness denotes, for example, the logarithm of the ratio between the response signal received level and the transmitted level or of that between the response signal received level and an assigned reference level or, as the case may be, reference value, referred to in the following as the response signal reference value. The value of the attenuation thickness is greater the lower the level is of the reflected signal received by the base station. The attenuation thickness is thus a measure of the seat occupancy, so that conclusions can be drawn from the attenuation thickness about the occupancy of the seat by a person or object.

It has hitherto been provided in the HOBBIT system preferably to integrate the central base station in the roof of the motor vehicle and the reflectors in its seat.

To reduce the required harmonization effort and production costs, it is often desirable on the part of vehicle manufacturers not to provide the base station in a motor vehicle roof element or, as the case may be, cockpit. Additional costs moreover arise in the case of the HOBBIT system from having to provide the components on the reflectors effecting reflector signal modulation there.

International patent publication WO 97/30864 A1 and U.S. Pat. No. 6,043,743 each describe a seat occupancy detection system having a transmitting apparatus, a receiving apparatus and a base station.

### SUMMARY OF THE INVENTION

It is accordingly an object of the invention to provide a device for detecting the occupancy of a seat which overcomes the above-mentioned disadvantages of the prior art devices of this general type, which provides an improved seat occupancy detection systems.

The idea underlying the present invention is for a device for detecting seat occupancy to have at least one transmitting apparatus for emitting signals, and the at least one transmitting apparatus is located at a first position in the seat. At least one receiving apparatus for receiving the emitted signals, is provided. The at least one receiving apparatus is located at a second position in the seat distanced from the first such that a person occupying the seat will be situated at least partially in the signal path between the at least one transmitting apparatus and at least one receiving apparatus for influencing the signals as a function of seat occupancy. At least one base station is connected, for generating the emitted signals, to the at least one transmitting apparatus and, for evaluating the received signals, to the at least one receiving apparatus. The device further has at least one sensor apparatus for determining a seat adjusted position, with the seat position data registered thereby being taken into account when the received signals are evaluated. The reliability of the device will be further enhanced thereby.

The present invention thus offers the advantage compared to the known approaches according to the prior art in that the base station will not have to be mounted in the motor vehicle roof. Therefore the base station will no longer be subject to the stringent temperature requirements applying to installation in the roof area.

Thanks to being integrated completely in the motor vehicle seat the inventive device is furthermore independent of the type of bodywork or, as the case may be, motor vehicle. The motor vehicle seat having an integrated device according to the invention needs consequently to be set in position only once in the course of production. The motor vehicle seat having an integrated device can hence be integrated simply and economically in any motor vehicle without resetting the device.

The present invention further offers the advantage compared to the prior art that the emitted signals will have to cover only one signal path and no additional reflection path. The at least one receiving apparatus will hence be able to register signals of relatively greater power, which is advantageous for the ensuing evaluation process. The ascertained data will consequently be able to be diagnosed well because adequate and reliable communication will still be possible when the seat is occupied.

The individual signals not being reflected, the at least one receiving apparatus can be embodied having reduced requirements because, as already explained above, the received signals will have a relatively greater power owing to the lower attenuation.

With no reflectors being provided in the inventive device in contrast to the HOBBIT system developed to date, the inventive device can be constructed with fewer components and hence more simply and economically. The transmitting or, as the case may be, receiving apparatuses can be integrated in the seat, for example as a foil structure or in the form of textile antennas, and suchlike.

With no reflection being provided and the attenuation being less, as already explained above the received signals will have a relatively greater power. Losses on the feeders to the transmitting and receiving apparatuses will consequently be more acceptable. Losses due to different types of seat heating will likewise have little impact on the device according to the invention.

A further advantage is that the transmitter power can, as and when required, also be advantageously reduced owing to the single signal path, with the lower attenuation ensuring that adequate receive signals can then still be expected.

According to a preferred development the at least one transmitting apparatus is embodied as a sending antenna and is integrated in the seat backrest. The at least one receiving apparatus is analogously preferably embodied as a receiving antenna and integrated in the seat sitting area. It is, however, obvious to someone skilled in the art that the at least one sending antenna and at least one receiving antenna can also be located elsewhere in the seat at a distance from each other. The at least one transmitting apparatus can in particular also be integrated in the seat sitting area and the at least one receiving antenna, by contrast, in its backrest.

According to a further preferred development the at least one transmitting apparatus is located in the seat backrest or sitting area in such a way that a person occupying the seat will at least partially not directly mask the at least one transmitting apparatus. For example, the at least one transmitting apparatus will be set in foam so that direct masking will be prevented. It is also conceivable for the at least one transmitting apparatus to be integrated in the seat in such a way, for example, that a person of smaller stature or slighter build will only partially mask the transmitting apparatus and a person of larger stature or, as the case may be, more corpulent build will mask the transmitting apparatus completely. This will enable additional classifying of the person occupying the seat. When the at least one transmitting apparatus is not directly masked by the person occupying the seat it will be ensured that the signals emitted by the at least one transmitting apparatus will not be attenuated to such an extent that they can no longer be registered by the at least one receiving apparatus. The at least one receiving apparatus is analogously preferably located in the seat sitting area or backrest in such a way that a person occupying the seat will at least partially mask the at least one receiving apparatus. This will ensure that the emitted signals wave field is altered as a function of seat occupancy. Reliable registering of the occupancy of a seat by a person will hence be provided. This concept can alternatively also be applied vice versa to the effect that the at least one receiving apparatus will at least partially not be masked by a person occupying the seat and a person occupying the seat will at least partially mask the one transmitting apparatus. Owing to the large distance between the transmitting apparatus and receiving apparatus the problem of crosstalk therebetween no longer arises, meaning that the transmitter power can be varied within a wider range owing to the decoupling of reciprocal electromagnetic effects between transmitting and receiving apparatuses. This allows an optimal balance to be achieved between transmitter power and signal quality.

According to a further preferred exemplary embodiment the device has one transmitting apparatus in the seat backrest and a plurality of receiving apparatuses in its sitting area. It is, however, obvious to someone skilled in the art that a plurality of transmitting apparatuses can also be located in the seat backrest and only one or a plurality of receiving apparatuses located in its sitting area, or vice versa. This will render the system less sensitive to other interfering high-frequency transmitters as these interference signals will be attenuated by the thickness of the body of the person occupying the seat.

The base station advantageously has a switch apparatus for selecting the receiving apparatuses respectively requiring to be evaluated. This is particularly advantageous when the individual receiving apparatuses are connected to the base station via a common radio link. The base station will as a result always be able to discern from which receiving apparatus the signals requiring to be evaluated are being conveyed.

The at least one base station preferably generates the emitted signal and conveys it in modulated form to the at least one receiving apparatus over a suitable link, for example a radio link or suchlike.

According to a further preferred development the apparatuses can in each case be used as both transmitting and receiving apparatuses, with the base station preferably including a changeover apparatus for changing over the at least one transmitting apparatus to at least one receiving apparatus and for changing over the at least one receiving apparatus to at least one transmitting apparatus. This will enable the measuring results to be plausibility checked, for example, and any device malfunctions to be registered simply and economically.

The base station advantageously has a local oscillator that is common to the at least one transmitting apparatus and at least one receiving apparatus and whose function is to condition the signals. As a result, the expensive local oscillators will have to be provided once only in the base station for shared use.

According to a further preferred exemplary embodiment the plurality of transmitting apparatuses and/or receiving apparatuses are connected to the base station via in each case an individual high-frequency line. The base station will as a result always be able to discern from which receiving apparatus the received signals have originated or, as the case may be, to which transmitting apparatus the generated and modulated signals have been conveyed. The plurality of transmitting apparatuses can, however, alternatively also be connected to the base station via one common high-frequency line and/or the plurality of receiving apparatuses likewise thereto via one common high-frequency line. This, in particular, is a more economical variant. In this case other known measures will have to be taken to designate the individual apparatuses.

According to a further preferred exemplary embodiment, each transmitting apparatus and/or receiving apparatus has its own base station. This will ensure reliable detection of the respective apparatuses, with it being possible for the evaluated signals then to be evaluated jointly for a plausibility check.

The at least one transmitting apparatus is embodied as, for instance, a square, long stretched-out, wire-form, or otherwise structured sending antenna. The at least one transmitting apparatus and the at least one receiving apparatus advantageously have the same structure so as to ensure changeover by the changeover apparatus without a reduction in power.

Other features which are considered as characteristic for the invention are set forth in the appended claims.

Although the invention is illustrated and described herein as embodied in a device for detecting the occupancy of a seat, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, cross-sectional view of a seat having a first preferred exemplary embodiment of an inventive device according the invention;

FIG. 2 is a diagrammatic, cross-sectional view of the seat having the inventive device according to a second preferred exemplary embodiment; and

FIG. 3 is a diagrammatic, cross-sectional view of the seat having the inventive device according to a third preferred exemplary embodiment.

### DESCRIPTION OF THE PREFERRED EMBODIMENTS

In all the figures of the drawing, sub-features and integral parts that correspond to one another bear the same reference symbol in each case. The term “person occupying the seat” refers in the preceding and following to an adult person, a child, or an infant occupying a child seat.

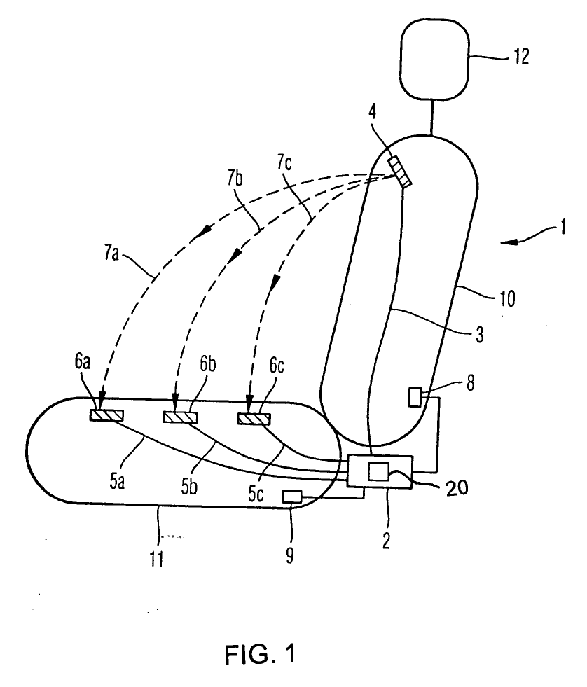

Referring now to the figures of the drawing in detail and first, particularly, to FIG. 1 thereof, there is shown an illustration of a device for detecting the occupancy of a seat 1, in particular a motor vehicle seat 1, according to a first preferred exemplary embodiment of the present invention.

As shown in FIG. 1, the device according to the present exemplary embodiment has a common base station 2 located, for example, below a backrest 10 and behind a sitting area 11 of the seat 1. According to the present exemplary embodiment the base station 2 is preferably connected via a high-frequency line 3 to an assigned transmitting apparatus 4 integrated in, for example, the upper area of the backrest 10 in the seat 1.

The transmitting apparatus 4 is preferably embodied as a sending antenna and integrated in the backrest 10 of the seat 1 in such a way that a person occupying the seat 1 will not mask at least a part of the sending antenna 4. The sending antenna 4 can be embodied as, for example, a rectangular or long stretched-out antenna mounted horizontally in the upper area of the backrest 10. A plurality of transmitting apparatuses can, of course, also to be integrated anywhere in the seat 1 and having any embodiments.

As can further be seen from FIG. 1, the sending antenna 4 is preferably mounted inclined in the backrest 10 of the seat 1 in such a way that the sending antenna 4 will be oriented for optimal emission of signals from the sending antenna 4 to assigned receiving apparatuses.

As shown in FIG. 1, according to the present example the base station 2 is connected to assigned receiving apparatuses 6a, 6b, 6c via in each case separate lines 5a, 5b, 5c, with the lines in turn preferably being embodied as high-frequency lines for transmitting high-frequency signals. As already explained above, waves having a frequency of 2.45 GHz are advantageously employed as signals. It is, however, obvious to someone skilled in the art that it is also possible to use other frequencies preferably having similar diffraction, attenuation and/or reflection properties with reference to persons or objects occupying the seats.

The receiving apparatuses 6a, 6b, 6c are advantageously embodied as receiving antennas 6a, 6b, 6c. As is also shown in FIG. 1, according to the present exemplary embodiment the receiving antennas 6a, 6b, 6c are integrated in the sitting area 11 of the seat 1. Five receiving antennas, for example, can be provided in the sitting area 11 of the seat 1, with one receiving antenna being assigned in each case to a corner of the sitting area 11 and the remaining receiving antenna being provided in the center of the sitting area 11. The individual receiving antennas are preferably located in the sitting area 11 in such a way that a person occupying the seat 1 will completely mask at least one of the receiving antennas for influencing the received wave field. It is obvious to someone skilled in the art that to ensure the above described function the receiving antennas can be positioned in all manners and ways in the sitting area. The receiving apparatuses 6a, 6b, 6c can, for example, also be embodied as a rectangular or long stretched-out antenna. Any number of receiving antennas can, of course, be integrated anywhere in the seat 1 and having any embodiments.

During operation the base station 2 generates and modulates transmission signals 7a, 7b, 7c which are transmitted from the base station 2 to the sending antenna or antennas 4 over the high-frequency line 3 and emitted by the sending antennas 4.

The emitted transmission signals 7a, 7b, 7c are received by the assigned receiving apparatuses 6a, 6b, 6c and forwarded via the respectively assigned lines 5a, 5b, 5c to, in each case, the common base station 2 for evaluation of the received signals.

A common local oscillator 20 which converts the received signal frequency to a frequency band having a lower frequency by adding a local oscillator signal of, for example, 2 GHz is preferably integrated in the base station 2. This is advantageous for ensuing frequency analysis and power measuring because simpler and more economical components can be used for evaluating the received signals and expensive analog/digital evaluation components can be dispensed with.

Since both the sending antenna 4 and the receiving antennas 6a, 6b, 6c are connected to the common base station 2, and hence to the common local oscillator 20, a further advantage in terms of high-frequency technology ensues in that any variations in the individual frequency ranges due to external interference will be compensated during differential evaluating owing to the common base station. This will ensure good noise correlation and hence advantageous noise suppression. As the local oscillator signal may also be affected by the external interference, the converted mixed signal resulting from the received and local oscillator signal will, when differential analysis is carried out, again be within the specified frequency band. This will ensure optimal evaluation of the received signals even when there is external interference.

As is further shown in FIG. 1, a sensor apparatus 8 for measuring the position of the backrest 10 of the seat 1 and a sensor apparatus 9 for measuring the position of the sitting area 11 of the seat 1 are preferably provided and connected to the base station 2 via suitable data links. The received signals received by the base station 2 can as a result be evaluated more reliably taking the respective sitting position into account. It is obvious to someone skilled in the art that sensor apparatuses for measuring all variations of the sitting position can be provided. In modern motor vehicles there are already sensor apparatuses for detecting respectively current sitting positions, with advantageous use being made of sensor apparatuses of said type.

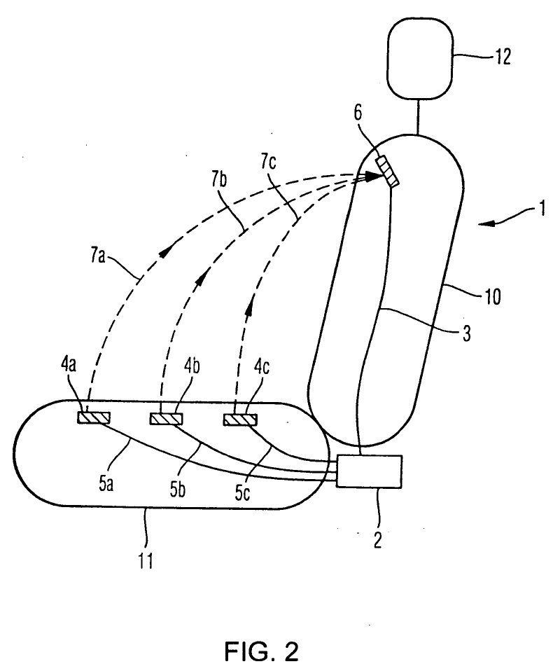

FIG. 2 is a schematic of an inventive device according to a second exemplary embodiment of the present invention. To avoid repetitions, reference is made where non-explained components and functions are concerned to the explanations already given in connection with the first exemplary embodiment according to FIG. 1.

In contrast to the first exemplary embodiment, according to the second exemplary embodiment a plurality of sending antennas 4a, 4b, 4c is provided each of which is integrated in the sitting area 11 of the seat 1, with its being possible to retain the receiving antennas individual mounting positions in the sitting area 11 according to the first exemplary embodiment.

According to the present exemplary embodiment a receiving antenna 6 is analogously integrated in the upper area of the backrest 10 of the seat 1.

As shown in FIG. 2, according to the present exemplary embodiment the signals generated and modulated by the base station 2 are conveyed over the high-frequency lines 5a, 5b, Sc to the respectively assigned sending antennas 4a, 4b, 4c and emitted by the sending antennas 4a, 4b, 4c toward the receiving antenna 6.

The sending antennas 4a, 4b, 4c and receiving antenna 6 are, analogously to the first exemplary embodiment, preferably positioned with respect to each other such that a person occupying the seat will be located at least partially in the signal path of the signals 7a, 7b, 7c between the sending antennas and receiving antenna for influencing the corresponding wave field.

With regard to the other components and functioning modes, reference is made to the first exemplary embodiment.

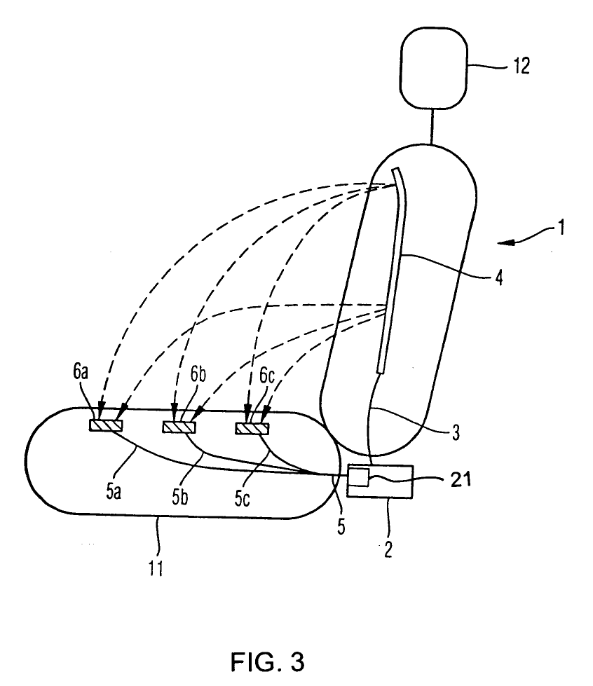

FIG. 3 is a schematic view of an inventive device according to a third preferred exemplary embodiment of the present invention. Components and their functioning modes already described in the first and second exemplary embodiment will not be further explained; reference is instead made to the preceding explanations.

As can be seen from FIG. 3, the sending antenna 4 is, in contrast to the preceding exemplary embodiments, embodied as a horizontally long stretched-out sending antenna, with preferably two such sending antennas being integrated parallel to each other in the lateral area of the backrest 10 of the seat 1. This will ensure that the sending antennas 4 will be at least partially not masked by a person occupying the seat 1 so that sufficiently high transmitter power can be achieved.

A further difference compared to the preceding exemplary embodiments is that the receiving apparatuses 6a, 6b, 6c are connected to the base station 2 via an ultimately common signal lead 5. This will enable the signal leads to be realized more economically and with less technical effort.

To assign the individual received signals to the corresponding receiving antennas 6a, 6b, 6c the base station 2 preferably has a switch apparatus 21 by which the base station connects or, as the case may be, disconnects the individual receiving apparatuses 6a, 6b, 6c. The base station 2 will as a result be able at any time to discern from which of the connected receiving antennas 6a, 6b, 6c the received signals currently being received have originated, thus ensuring reliable evaluating.

It is obvious to someone skilled in the art that the above cited exemplary embodiments can also be combined with each other. Further modifications are, of course, also encompassed within the protective scope of the present inventive idea. For example, it is possible both in the sitting area 11 and in the backrest 10 to provide one or more antennas that can be used both as a sending antenna and as a receiving antenna. In this case the base station 2 can, for example, initially switch the antennas provided in the backrest 10 as sending antennas and the antennas provided in the sitting area 11 as receiving antennas, with the antennas in the backrest 10 being switched as receiving antennas for a plausibility check and the antennas in the sitting area 11 of the seat 1 being switched as sending antennas for a further measurement. The results of the individual measurements can be combined with each other for joint, reliable evaluation.

The individual antennas can be embodied as, for example, square, rectangular, long stretched-out, or otherwise shaped antennas, and located anywhere in the seat 1. The only decisive factor is that the sending antennas and receiving antennas must be mutually positioned and distanced from each other such that a person occupying the seat will measurably influence the wave field between the sending antennas and receiving antennas as a function of seat occupancy. The signal attenuation is registered by the base station 2 and evaluated for detecting seat occupancy. If occupancy of a seat by, for example, an adult person is detected, then an apparatus, for example a passenger airbag or other measures of personal protection, connected to the base station 2 can be activated and rendered functional thereby.

The present invention thus provides an advantageous device for detecting the occupancy of a seat, for example a motor vehicle seat. Apart from the already above-cited advantages compared to the approaches according to the prior art, the present invention offers the additional advantage that the system will be less sensitive to other interfering high-frequency transmitters. A person occupying the seat who has a predetermined body thickness will attenuate the additional interfering high-frequency transmitters generally located in front of the person so that the signals emitted by the transmitters will be attenuated by the body thickness of the person. This is advantageous particularly when the receiving antennas are located in the seat sitting area.

When the individual antennas are located in the seat sitting area or, as the case may be, its backrest 10 there will be the further advantage that owing to the large distance between the transmitting apparatus and receiving apparatus the problem of reciprocal electromagnetic effects therebetween will be avoided. The transmitter power can as a result be varied within a wider range so that a balance can be achieved between transmitter power and signal quality in keeping with the required application and customer specific preferences.

In contrast to numerous approaches according to the prior art the inventive system is not based on measuring mechanical changes or, as the case may be, loads. This is advantageous in terms of the system useful life as there will be no occurrence of wear-and-tear due to mechanical loading.

Albeit the present invention has been described above with the aid of preferred exemplary embodiments, it is not restricted thereto but can be multifariously modified.

Antennas can also be integrated in, for instance, a headrest 12 of the seat 1, or elsewhere therein.

Each receiving and/or transmitting apparatus can furthermore have its own base station or be connected to its own, in each case specifically assigned base station. The individual signals can as a result be processed directly at the receiving and/or transmitting apparatuses, thereby enabling any connection leads required to be embodied more simply in terms of high-frequency technology and more economically.

A further modification could be, for example, for further communication devices, such as a Bluetooth port or suchlike, to use the transmitting and/or receiving apparatus to couple into the motor vehicle system for, for instance, service measures, so that the transmitting and/or receiving apparatus will serve as a functional component of the entire additional communication system. For example a mobile telephone could also log into the motor vehicle system via a Bluetooth port using the transmitting and/or receiving apparatus so that the user of the motor vehicle will only need to position the mobile phone anywhere in the vehicle to set up a connection to the handsfree talking system integrated in said vehicle.

This application claims the priority, under 35 U.S.C. §119, of German patent application No. 10 2004 050 884.4, filed Oct. 19, 2004; the entire disclosure of the application is herewith incorporated by reference.

We claim:

1. A device for detecting an occupancy of a seat, comprising:
at least one transmitting apparatus for outputting emitted signals and disposed at a first position in the seat;
at least one receiving apparatus for receiving the emitted signals and disposed at a second position in the seat, the second position being distanced from the first position such that a person occupying the seat will be situated at least partially in a signal path between said at least one transmitting apparatus and said at least one receiving apparatus for influencing the emitted signals in dependency on seat occupancy;
at least one base station connected, for generating the emitted signals, to said at least one transmitting apparatus and, for evaluating received signals, to said at least one receiving apparatus; and
at least one sensor apparatus for determining an adjusted position of the seat in a form of seat position data, and the seat position data being taken into account when the received signals are evaluated.

2. The device according to claim 1, wherein:
said at least one transmitting apparatus is a sending antenna and is integrated in a backrest of the seat; and
said at least one receiving apparatus is a receiving antenna and is integrated in a sitting area of the seat.

3. The device according to claim 1, wherein said at least one transmitting apparatus is disposed in a backrest or a sitting area of the seat such that a person occupying the seat will at least partially not directly block said at least one transmitting apparatus.

4. The device according to claim 1, wherein said at least one receiving apparatus is disposed in a sitting area or backrest of the seat and is embodied such that the person occupying the seat will at least partially mask said at least one receiving apparatus.

5. The device according to claim 1, wherein said at least one transmitting apparatus is a single transmitting apparatus disposed in a backrest of the seat and said at least one receiving apparatus is one of a plurality of receiving apparatuses disposed in a sitting area of the seat.

6. The device according to claim 5, wherein said base station has a switch apparatus for selecting which of said receiving apparatuses is to be evaluated.

7. The device according to claim 1, wherein said at least one base station generates and modulates the emitted signals.

8. The device according to claim 1, wherein:
said at least one receiving apparatus and said at least one transmitting apparatus are in each case embodied as both a transmitting and receiving apparatus; and
said base station having a changeover apparatus for changing over said at least one transmitting apparatus to said at least one receiving apparatus and said at least one receiving apparatus to said at least one transmitting apparatus.

9. The device according to claim 1, wherein said base station has a local oscillator that is common to said at least one transmitting apparatus and said at least one receiving apparatus and whose function is to condition the emitted signals and/or the received signals.

10. The device according to claim 1, further comprising high-frequency lines connecting said at least one transmitting apparatus and said at least one receiving apparatus to said base station.

11. The device according to claim 1, wherein said base station is one of a plurality of base stations and each of said at least one transmitting apparatus and said at least one receiving apparatus is connected to one of said base stations.

12. The device according to claim 1, wherein at least one of said at least one transmitting apparatus or said at least one receiving apparatus is embodied as an apparatus selected from the group consisting of a square shaped antenna, a rectangular shaped antenna, a long stretched-out shaped antenna, and a wire-form antenna.

13. The device according to claim 1, wherein said at least one transmitting apparatus is one of a plurality of transmitting apparatuses disposed in a sitting area of the seat and said at least one receiving apparatus is one single receiving apparatus disposed in a back rest of the seat.

14. The device according to claim 13, wherein said base station has a switch apparatus for selecting which of said transmitting apparatuses is to be driven.

15. The device according to claim 14, further comprising:
a first common high-frequency line for connecting said transmitting apparatuses to said base station; and
a second common high-frequency line connecting said receiving apparatus said base station.

16. The device according to claim 1, wherein the device detects the occupancy of the seat disposed in a motor vehicle.
